(19) United States
(12) Patent Application Publication
(10) Pub. No.: US 2019/0131701 A1
(43) Pub. Date: May 2, 2019

(54) ARRAY ANTENNA DEVICE

(71) Applicant: MITSUBISHI ELECTRIC CORPORATION, Tokyo (JP)

(72) Inventors: Hikaru WATANABE, Tokyo (JP); Satoshi YAMAGUCHI, Tokyo (JP); Masataka OTSUKA, Tokyo (JP); Hideki MORISHIGE, Tokyo (JP)

(73) Assignee: MITSUBISHI ELECTRIC CORPORATION, Tokyo (JP)

(21) Appl. No.: 16/096,408

(22) PCT Filed: Jun. 14, 2016
(86) PCT No.: PCT/JP2016/067668

§ 371 Date: Oct. 25, 2018

(51) Int. Cl. H01Q 1/52; H01Q 21/06; H01Q 21/00

(52) U.S. Cl. CPC H01Q 1/523; H01Q 21/0006; H01Q 21/065

(57) ABSTRACT

A parallel line formed on the same plane as a patch element, close to the patch element, in a direction that is a magnetic field direction of a patch antenna and parallel to the polarization direction of the patch antenna, and a bent line shaped so as to be bent between adjacent patch elements and configured to connect their parallel lines to each other, form a coupling line, which couples part of an electromagnetic wave excited by one of the patch elements to its adjacent patch antenna, and, in the coupling line, a gap between the parallel line and the patch element and a length of the bent line are set so that an electromagnetic wave coupled from one patch antenna to its adjacent patch antenna via space and an electromagnetic wave coupled from the one patch antenna to the adjacent patch antenna via the coupling line cancel each other.

### TECHNICAL FIELD

The present invention relates to an array antenna device configured such that a planar antenna, such as a patch antenna, is used as an element antenna, and the element antennas are arrayed in plurality.

### BACKGROUND ART

Hitherto, a high level of transmission/reception of an electromagnetic wave from a varying arrival direction has been demanded of radars and mobile communication devices, and a method has been used in response to the demand which adopts an array antenna device including an array of a plurality of element antennas to control a main beam direction.

In the array antenna device, the gap between adjacent element antennas in the array is required to be close in order to avoid unnecessary emission called grating lobe in the visible range in beam scanning.

However, an array in which the gap between adjacent element antennas is close is high in the level of mutual coupling between the element antennas, and the resultant problems are low antenna gain and directivity disturbance.

Various methods of reducing the mutual coupling between element antennas are disclosed for the purpose of solving those problems (see Patent Literature 1 and Patent Literature 2, for example).

For instance, in a method disclosed in Patent Literature 1, at least one of a metal body or a dielectric substance is formed in the vicinity of element antennas. In Patent Literature 2, there are disclosed a method in which each element antenna is covered with a metal wall and a method in which electromagnetic band gap (EBG) elements are arranged at equal intervals between element antennas.

### CITATION LIST

### Patent Literature

[PTL 1] JP 59-194517 A

[PTL 2] JP 2010-28182 A

### SUMMARY OF INVENTION

### Technical Problem

Patent Literature 1, however, has a problem in that, while a description about providing a metal body and/or a dielectric substance in the vicinity of dipole antennas or circular horn antennas is included, there is no disclosure or even hint about the arrangement, specific structure, and the like of the metal body or the dielectric substance that reduce the mutual coupling when this method is applied to a patch antenna or a similar planar antenna.

Patent Literature 2 has a problem as well because of the need for the metal wall, which is an additional member, and the need to form through-holes for arranging the EBG elements. The problem is a significant increase in cost due to the material cost required for the structure for reducing the mutual coupling, and an additional manufacturing cost for the added manufacturing step of forming the through-holes.

The present invention has been made to solve the problems described above, and an object of the present invention is therefore to provide an array antenna device capable of satisfactorily reducing mutual coupling between element antennas without inviting a significant increase in cost.

### Solution to Problem

According to one embodiment of the present invention, there is provided an array antenna device including a plurality of patch antennas arrayed in at least a polarization direction of the plurality of patch antennas, the array antenna device including: a parallel line formed for each of the plurality of patch antennas in parallel to the polarization direction of the patch antenna, on the same plane as a patch element of the patch antenna, close to the patch element and in a magnetic field direction of the patch antenna; and a bent line configured to connect the parallel line, which is formed close to the patch element, to another parallel line, which is formed close to another patch element, and shaped so as to be bent between adjacent patch elements, in which the parallel line and the bent line form a coupling line, which couples part of an electromagnetic wave excited by the patch element to an adjacent patch antenna, and in which, in the coupling line, a gap between the parallel line and the patch element and a length of the bent line are set so that an electromagnetic wave coupled from one patch antenna to an adjacent patch antenna via space and an electromagnetic wave coupled from the one patch antenna to the adjacent patch antenna via the coupling line cancel each other.

### Advantageous Effects of Invention

According to the array antenna device of the present invention, the parallel line formed on the same plane as a patch element, close to the patch element, in a direction that is the magnetic field direction of the patch antenna and that is parallel to the polarization direction of the patch antenna, and the bent line shaped so as to be bent between adjacent patch elements and configured to connect their parallel lines to each other, form the coupling line, which couples part of an electromagnetic wave excited by one of the patch elements to its adjacent patch antenna, and, in the coupling line, a gap between the parallel line and the patch element and the length of the bent line are set so that an electromagnetic wave coupled from one patch antenna to its adjacent patch antenna via space and an electromagnetic wave coupled from the one patch antenna to the adjacent patch antenna via the coupling line cancel each other.

Thus, it is possible to satisfactorily reduce mutual coupling between element antennas without inviting a significant increase in cost.

### BRIEF DESCRIPTION OF DRAWINGS

FIG. 1 is a plan view for illustrating an array antenna device according to a first embodiment of the present invention.

FIG. 2 is a sectional view of the array antenna device of FIG. 1 taken along the line I-I.

FIG. 3 is an explanatory graph for showing the amount of mutual coupling in the array antenna device according to the first embodiment of the present invention by comparison between a case in which a coupling line is included and a case in which there is no coupling line.

FIG. 4 is an explanatory graph for showing an emission pattern in the array antenna device according to the first embodiment of the present invention by comparison between a case in which a single patch antenna is used, a case in which a coupling line is included, and a case in which there is no coupling line.

FIG. 5 is another explanatory graph for showing an emission pattern in the array antenna device according to the first embodiment of the present invention by comparison between a case in which a single patch antenna is used, a case in which a coupling line is included, and a case in which there is no coupling line.

FIG. 6 is a plan view for illustrating an array antenna device according to a second embodiment of the present invention.

FIG. 7 is an explanatory graph for showing the amount of mutual coupling in the array antenna device according to the second embodiment of the present invention by comparison between a case in which a coupling line is included and a case in which there is no coupling line.

FIG. 8 is an explanatory graph for showing an emission pattern in the array antenna device according to the second embodiment of the present invention by comparison between a case in which a single patch antenna is used, a case in which a coupling line is included, and a case in which there is no coupling line.

FIG. 9 is another explanatory graph for showing an emission pattern in the array antenna device according to the second embodiment of the present invention by comparison between a case in which a single patch antenna is used, a case in which a coupling line is included, and a case in which there is no coupling line.

FIG. 10 is another plan view for illustrating the array antenna device according to the second embodiment of the present invention.

FIG. 11 is a plan view for illustrating an array antenna device according to a third embodiment of the present invention.

FIG. 12 is another plan view for illustrating the array antenna device according to the third embodiment of the present invention.

FIG. 13 is still another plan view for illustrating the array antenna device according to the third embodiment of the present invention.

FIG. 14 is yet still another plan view for illustrating the array antenna device according to the third embodiment of the present invention.

FIG. 15 is yet still another plan view for illustrating the array antenna device according to the third embodiment of the present invention.

FIG. 16 is yet still another plan view for illustrating the array antenna device according to the third embodiment of the present invention.

FIG. 17 is yet still another plan view for illustrating the array antenna device according to the third embodiment of the present invention.

### DESCRIPTION OF EMBODIMENTS

A description is now given of an array antenna device according to preferred embodiments of the present invention referring to the accompanying drawings, and throughout the drawings, like or corresponding components are denoted by like reference symbols to describe those components.

### First Embodiment

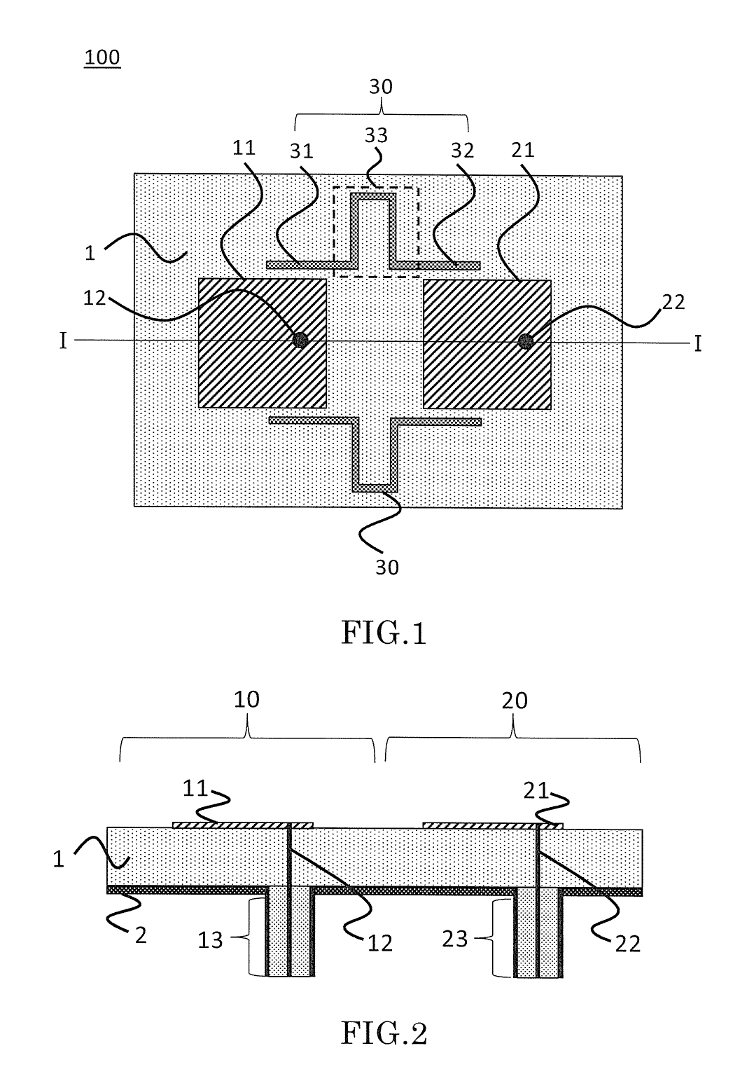

FIG. 1 is a plan view for illustrating an array antenna device according to a first embodiment of the present invention. FIG. 2 is a sectional view of the array antenna device of FIG. 1 taken along the line I-I. In FIG. 1 and FIG. 2, an array antenna device 100 includes a first patch antenna 10 and a second patch antenna 20, which are formed on a dielectric substrate 1, and two coupling lines 30 as well.

The first patch antenna 10 includes a patch element 11, which is formed on the dielectric substrate 1, a power feeding probe 12 and a coaxial line 13, which excite the patch element 11, and a ground plane 2, which is formed on a flat surface of the dielectric substrate 1 on the side opposite from the patch element 11.

Further, the second patch antenna 20 includes a patch element 21, which is formed on the dielectric substrate 1, a power feeding probe 22 and a coaxial line 23, which excite the patch element 21, and the ground plane 2.

The first patch antenna 10 and the second patch antenna 20 are arrayed so as to be adjacent to each other in a direction that is the polarization direction of the first patch antenna 10 and the second patch antenna 20. This makes the array of the first patch antenna 10 and the second patch antenna 20 an E-plane array.

The two coupling lines 30 are formed so as to be symmetrical with respect to the line I-I in FIG. 1, which passes through centers of the patch elements 11 and 21. The coupling lines 30 are each made up of a first parallel line 31, a second parallel line 32, and a bent line 33.

Each first parallel line 31 is formed close to the patch element 11 on the dielectric substrate 1 in a magnetic field direction of the first patch antenna 10 and the second patch antenna 20. Each first parallel line 31 is also a line formed in parallel to the polarization direction of the first patch antenna 10 and the second patch antenna 20.

Further, each second parallel line 32 is formed close to the patch element 21 on the dielectric substrate 1 in the magnetic field direction of the first patch antenna 20 and the second patch antenna 20. Each second parallel line 32 is also a line formed in parallel to the polarization direction of the first patch antenna 10 and the second patch antenna 20.

Each bent line 33 is a line connecting one first parallel line 31 and one second parallel line 32 to each other, and is bent in the shape of a crank between the patch element 11 and the patch element 21.

The operation of the array antenna device 100 configured as above is described below. First, an electromagnetic wave excited by the patch element 11 via the power feeding probe and the coaxial line 13, namely, an electromagnetic wave resultant from the excitation of the first patch antenna 10, is mostly emitted into free space.

Part of the electromagnetic wave excited by the patch element 11 is coupled to the coupling lines 30 in the array antenna device 100 configured as above because each first parallel line 31 is formed on the same plane as the patch element 11, close to the patch element 11, in a direction that is the magnetic field direction of the first patch antenna 10 and that is parallel to the polarization direction of the first patch antenna 10.

Part of the electromagnetic wave emitted into free space is coupled via free space to the second patch antenna 20 adjacent to the first patch antenna 10. Part of the electromagnetic wave coupled to the coupling lines 30, too, is coupled via the coupling lines 30 to the adjacent second patch antenna 20.

In the array antenna device according to the first embodiment of the present invention, it is desirable to set the length of each of the coupling lines 30 so that the electromagnetic wave coupled from the first patch antenna 10 to the second patch antenna 20 via free space and the electromagnetic wave coupled from the first patch antenna 10 to the second patch antenna 20 via the coupling lines 30 cancel each other.

Specifically, the gap from the patch element 11 to one first parallel line 31 and one second parallel line 32, the gap from the patch element 21 to another first parallel line 31 and another second parallel line 32, and the length of each bent line 33 are set so that the electromagnetic wave coupled from the first patch antenna 10 to the second patch antenna 20 via free space and the electromagnetic wave coupled from the first patch antenna 10 to the second patch antenna 20 via the coupling lines 30 have roughly equal amplitudes and phases reverse to each other.

An electromagnetic wave coupled from the second patch antenna 20 to the first patch antenna 10 at this point is similar to the electromagnetic wave coupled from the first patch antenna 10 to the second patch antenna 20 due to reversibility. Mutual coupling between the first patch antenna 10 and the second patch antenna 20 can accordingly be reduced.

Effects of the array antenna device 100 according to the first embodiment of the present invention are described below by comparison of the amount of mutual coupling between a case in which the coupling lines 30 are included and a case in which there is no coupling line, while giving a calculation example.

In the calculation, the gap between the first patch antenna 10 and the second patch antenna 20 is set to ½ of the free space wavelength, and the length of each side of the shape of the patch elements 11 and 12 and power feeding positions of the patch elements 11 and 12 are adjusted so that a match is ensured at a design center frequency (f/f0=1), in other words, so that the reflection coefficient is equal to or less than −20 dB.

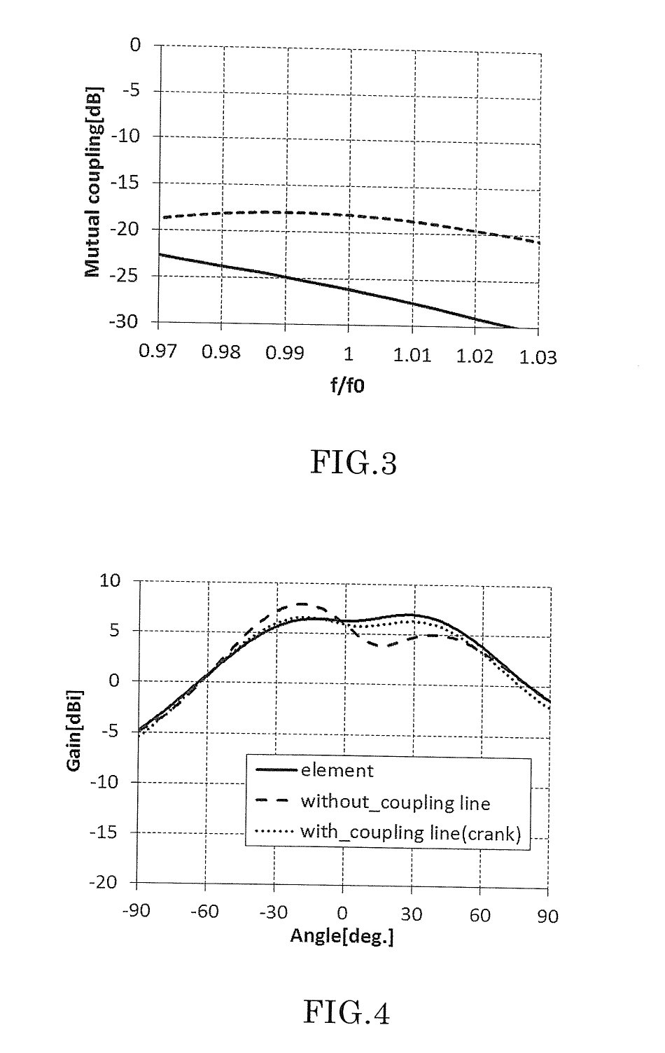

FIG. 3 is an explanatory graph for showing the amount of mutual coupling in the array antenna device according to the first embodiment of the present invention by comparison between a case in which a coupling line is included and a case in which there is no coupling line. In FIG. 3, the axis of abscissa indicates a frequency standardized by the design center frequency, and the axis of ordinate indicates the amount of mutual coupling between the first patch antenna 10 and the second patch antenna 20.

The amount of mutual coupling in the case where no coupling lines 30 are included is represented by the broken line in FIG. 3, and is −18.1 dB. The amount of mutual coupling in the case where the coupling lines 30 are included is represented by the solid line in FIG. 3, and is −26.1 dB. The comparison of the amount of mutual coupling between those cases reveals that mutual coupling is successfully reduced by 8.0 dB from the case of the related art in which there are no coupling lines 30.

FIG. 4 is an explanatory graph for showing an emission pattern in the array antenna device according to the first embodiment of the present invention by comparison between a case in which a single patch antenna is used, a case in which a coupling line is included, and a case in which there is no coupling line. In FIG. 4, the axis of abscissa indicates the angle, and the axis of ordinate indicates an emission pattern observed when the first patch antenna 10 is excited.

Patterns shown in FIG. 4 are: an emission pattern observed when the first patch antenna 10 is used alone (the solid line); an emission pattern observed when the first patch antenna 10 is excited, the coaxial line 23 of the second patch antenna 20 is match-terminated, and there are no coupling lines 30 (the broken line); and an emission pattern observed when the first patch antenna 10 is excited, the coaxial line 23 of the second patch antenna 20 is match-terminated, and the coupling lines 30 are included (the dotted line).

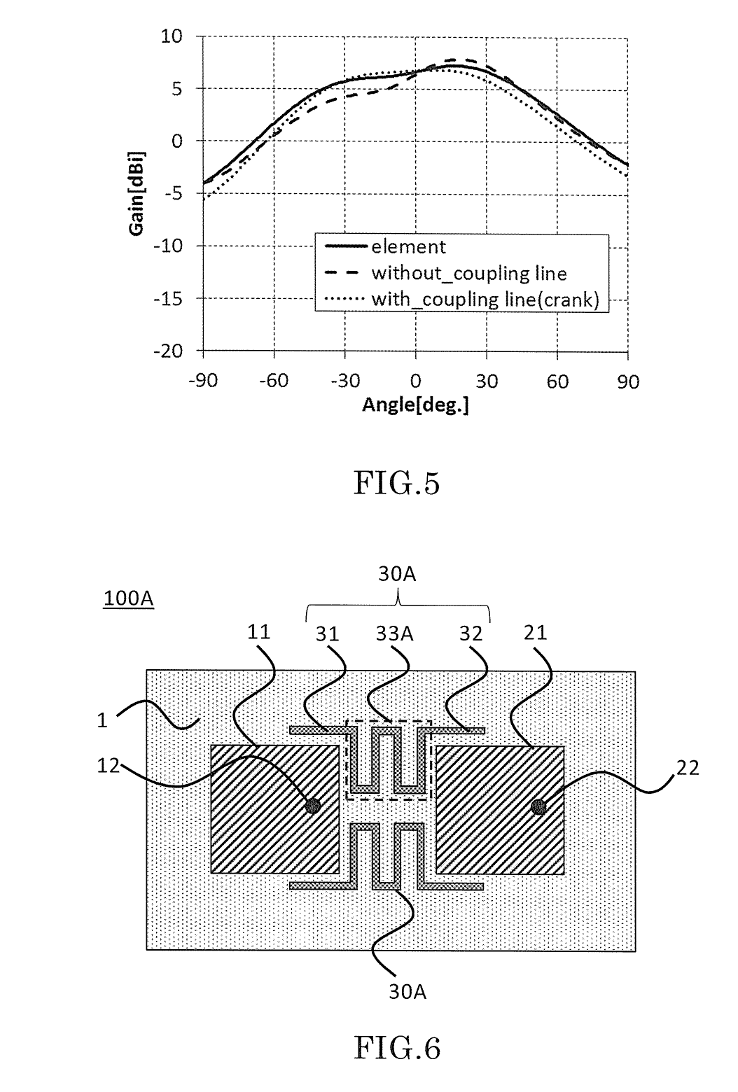

FIG. 5 is an explanatory graph for showing an emission pattern in the array antenna device according to the first embodiment of the present invention by comparison between a case in which a single patch antenna is used, a case in which a coupling line is included, and a case in which there is no coupling line. In FIG. 5, the axis of abscissa indicates the angle, and the axis of ordinate indicates an emission pattern observed when the second patch antenna 20 is excited.

Patterns shown in FIG. 5 are: an emission pattern observed when the second patch antenna 20 is used alone (the solid line); an emission pattern observed when the second patch antenna 20 is excited, the coaxial line 13 of the first patch antenna 10 is match-terminated, and there are no coupling lines 30 (the broken line); and an emission pattern observed when the second patch antenna 20 is excited, the coaxial line 13 of the first patch antenna 10 is match-terminated, and the coupling lines 30 are included (the dotted line).

It is understood from FIG. 4 that the emission pattern observed when the first patch antenna 10 is excited and the coupling lines 30 are included has, around a boresight, ripples smaller than the ones when the first patch antenna 10 is excited and there are no coupling lines 30, and is accordingly similar to the emission pattern observed when the first patch antenna 10 is used alone.

From FIG. 5, it is understood that, as is the case for the emission patterns observed when the first patch antenna 10 is excited, the emission pattern observed when the second patch antenna 20 is excited and the coupling lines 30 are included has smaller ripples around the boresight than when the second patch antenna 20 is excited and there are no coupling lines 30, and is similar to the emission pattern observed when the second patch antenna 20 is used alone.

Disturbance caused in emission characteristics by mutual coupling between the first patch antenna 10 and the second patch antenna 20 can accordingly be ameliorated by reducing the influence of the mutual coupling between the patch antennas.

As described above, according to the first embodiment, the parallel line formed on the same plane as a patch element, close to the patch element, in a direction that is the magnetic field direction of the patch antenna and that is parallel to the polarization direction of the patch antenna, and the bent line shaped so as to be bent between adjacent patch elements and configured to connect their parallel lines to each other, form the coupling line, which couples part of an electromagnetic wave excited by one of the patch elements to its adjacent patch antenna, and, in the coupling line, a gap between the parallel line and the patch element and the length of the bent line are set so that an electromagnetic wave coupled from one patch antenna to its adjacent patch antenna via space and an electromagnetic wave coupled from the one patch antenna to the adjacent patch antenna via the coupling line cancel each other.

Mutual coupling is accordingly reduced by controlling the phases of the electromagnetic waves, each of which is coupled to the patch antennas, through the amount of bend, that is, the line length, of the coupling line to cancel out the electromagnetic wave coupled to the patch elements via space and the electromagnetic wave coupled to the patch elements via the coupling line.

Another advantage is that the coupling line can be formed by etching in the same manufacturing step as the step of forming the patch elements of the patch antennas, which means no additional cost to form the coupling line.

Mutual coupling between element antennas can thus be reduced satisfactorily without inviting a significant increase in cost.

### Second Embodiment

FIG. 6 is a plan view for illustrating an array antenna device according to a second embodiment of the present invention. In FIG. 6, an array antenna device 100A includes coupling lines 30A in place of the coupling lines 30 illustrated in FIG. 1.

The coupling lines 30A are each made up of a first parallel line 31, a second parallel line 32, and a bent line 33A. Each bent line 33A is a line connecting one first parallel line 31 and one second parallel line 32 to each other, and is bent in the shape of a meander between the patch element 11 and the patch element 21.

The rest of the configuration is the same as the one described in the first embodiment with reference to FIG. 1, and a description on the rest is omitted. The operation of the array antenna device 100A configured as above, too, is the same as the operation described in the first embodiment, and a description on the operation is omitted.

Effects of the array antenna device 100A according to the second embodiment of the present invention are described below by comparison of the amount of mutual coupling between a case in which the coupling lines 30A are included and a case in which there is no coupling line, while giving a calculation example. Conditions of the calculation are the same as those in the first embodiment described above.

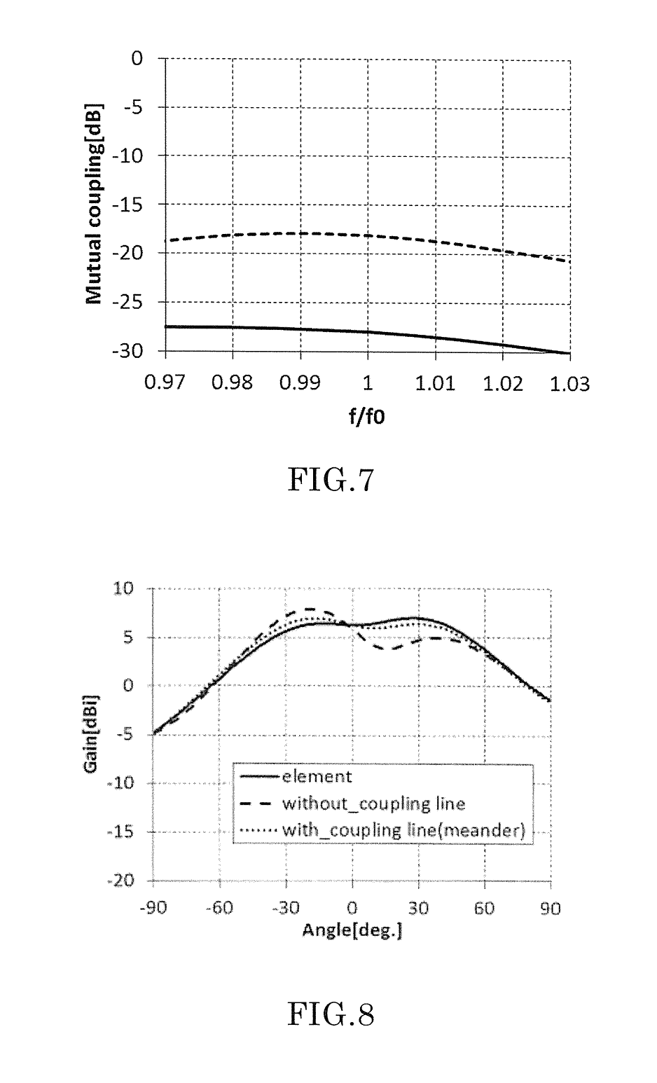

FIG. 7 is an explanatory graph for showing the amount of mutual coupling in the array antenna device according to the second embodiment of the present invention by comparison between a case in which a coupling line is included and a case in which there is no coupling line. In FIG. 7, the axis of abscissa indicates a frequency standardized by the design center frequency, and the axis of ordinate indicates the amount of mutual coupling between the first patch antenna 10 and the second patch antenna 20.

The amount of mutual coupling in the case where the coupling lines 30A are included and the amount of mutual coupling in the case where no coupling lines 30A are included are represented by the solid line and the broken line, respectively, in FIG. 7. The comparison of the amount of mutual coupling between those cases reveals that mutual coupling is successfully reduced by 10 dB from the case in which there are no coupling lines 30A.

FIG. 8 is an explanatory graph for showing an emission pattern in the array antenna device according to the second embodiment of the present invention by comparison between a case in which a single patch antenna is used, a case in which a coupling line is included, and a case in which there is no coupling line. In FIG. 8, the axis of abscissa indicates the angle, and the axis of ordinate indicates an emission pattern observed when the first patch antenna 10 is excited.

Patterns shown in FIG. 8 are: an emission pattern observed when the first patch antenna 10 is used alone (the solid line); an emission pattern observed when the first patch antenna 10 is excited, the coaxial line 23 of the second patch antenna 20 is match-terminated, and there are no coupling lines 30A (the broken line); and an emission pattern observed when the first patch antenna 10 is excited, the coaxial line 23 of the second patch antenna 20 is match-terminated, and the coupling lines 30A are included (the dotted line).

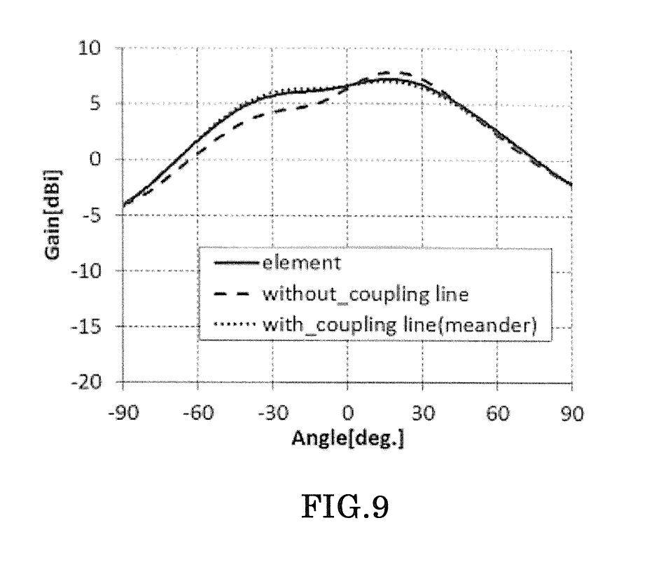

FIG. 9 is an explanatory graph for showing an emission pattern in the array antenna device according to the second embodiment of the present invention by comparison between a case in which a single patch antenna is used, a case in which a coupling line is included, and a case in which there is no coupling line. In FIG. 9, the axis of abscissa indicates the angle, and the axis of ordinate indicates an emission pattern observed when the second patch antenna 20 is excited.

Patterns shown in FIG. 9 are: an emission pattern observed when the second patch antenna 20 is used alone (the solid line); an emission pattern observed when the second patch antenna 20 is excited, the coaxial line 13 of the first patch antenna 10 is match-terminated, and there are no coupling lines 30A (the broken line); and an emission pattern observed when the second patch antenna 20 is excited, the coaxial line 13 of the first patch antenna 10 is match-terminated, and the coupling lines 30A are included (the dotted line).

It is understood from FIG. 8 that the emission pattern observed when the first patch antenna 10 is excited and the coupling lines 30A are included has, around a boresight, ripples smaller than the ones when the first patch antenna 10 is excited and there are no coupling lines 30A, and is accordingly similar to the emission pattern observed when the first patch antenna 10 is used alone.

From FIG. 9, it is understood that, as is the case for the emission patterns observed when the first patch antenna 10 is excited, the emission pattern observed when the second patch antenna 20 is excited and the coupling lines 30A are included has smaller ripples around the boresight than when the second patch antenna 20 is excited and there are no coupling lines 30A, and is similar to the emission pattern observed when the second patch antenna 20 is used alone.

Disturbance caused in emission characteristics by mutual coupling between the first patch antenna 10 and the second patch antenna 20 can accordingly be ameliorated by reducing the influence of the mutual coupling between the patch antennas.

According to the second embodiment, mutual coupling between element antennas can thus be reduced satisfactorily without inviting a significant increase in cost, as in the first embodiment described above.

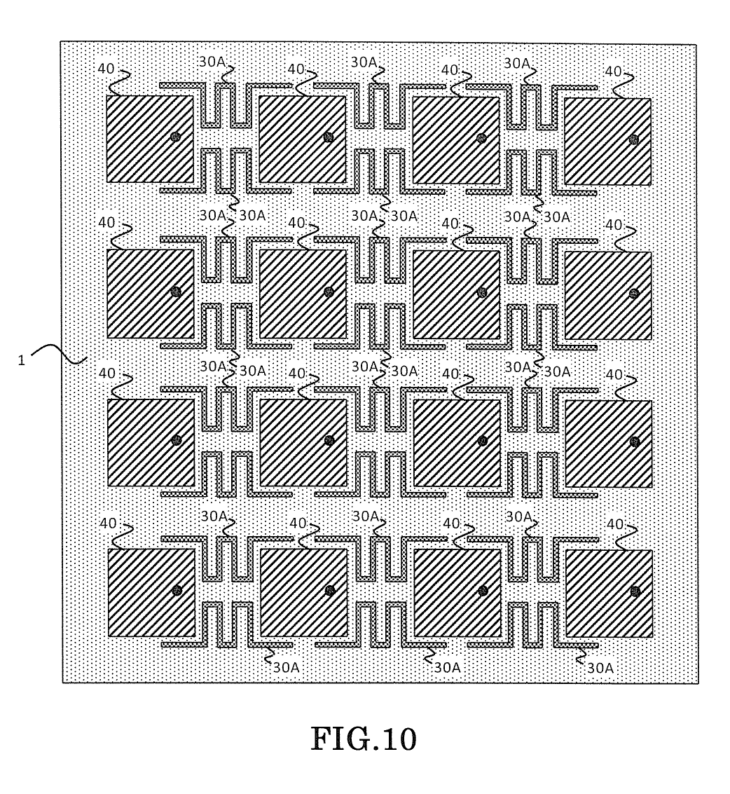

FIG. 10 is another plan view for illustrating the array antenna device according to the second embodiment of the present invention, and patch antennas 40 are arrayed two-dimensionally into a 4×4 array in FIG. 10. The coupling lines 30A in the second embodiment described above each have the bent line 33A, which is formed so as to be inserted between adjacent patch antennas 40.

Accordingly, it is physically possible to array the coupling lines 30A even when, for example, the patch antennas 40, from which the array antenna device 100 is formed, form a two-dimensional array with a narrow gap from one another as illustrated in FIG. 10, and mutual coupling between adjacent patch antennas 40 is reduced as a result.

### Third Embodiment

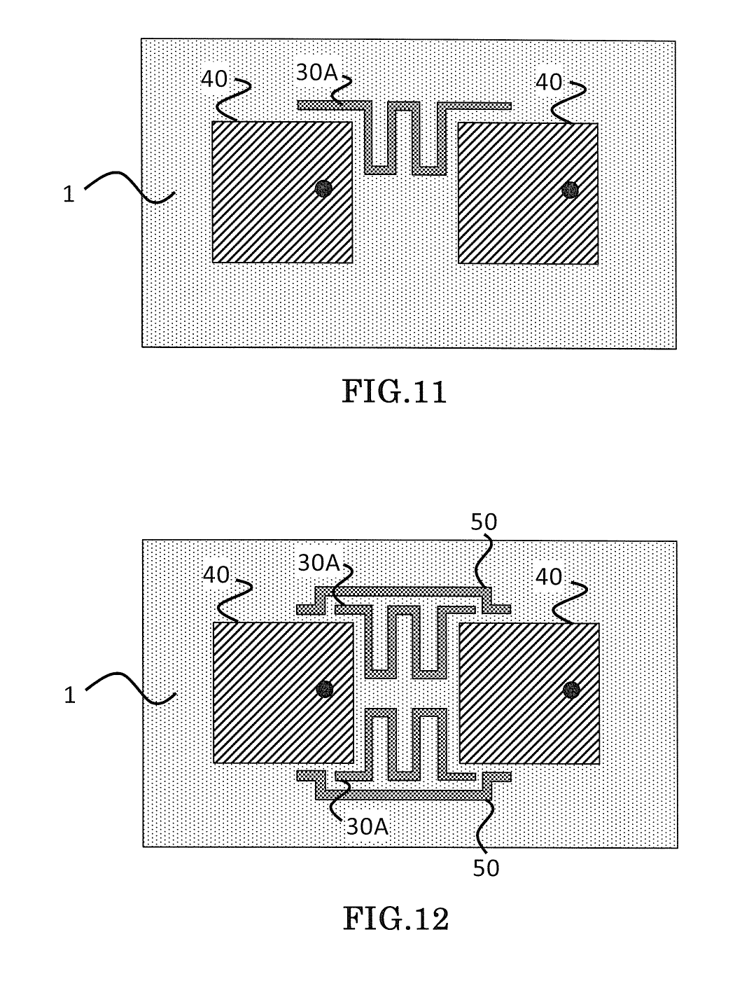

FIG. 11 to FIG. 17 are each a plan view for illustrating an array antenna device according to a third embodiment of the present invention. While the number and shape of the coupling lines are limited in the first embodiment and the second embodiment, the present invention is not limited thereto.

For instance, one coupling line 30A may be formed between adjacent patch antennas 40 as illustrated in FIG. 11, and three or more coupling lines 30A and 50 may be formed between adjacent patch antennas 40 as illustrated in FIG. 12.

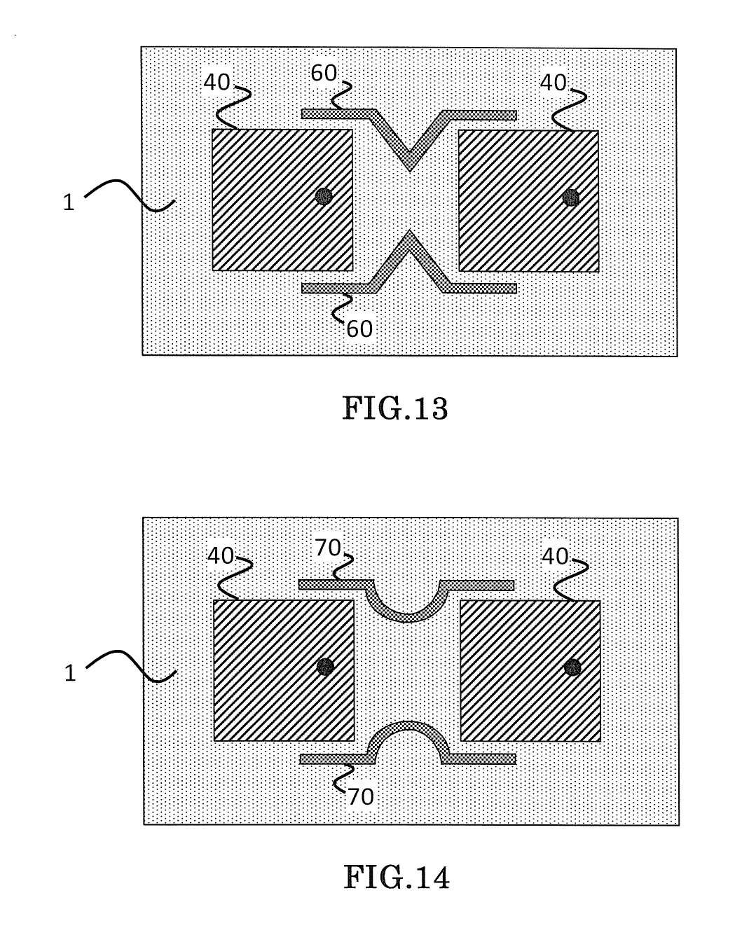

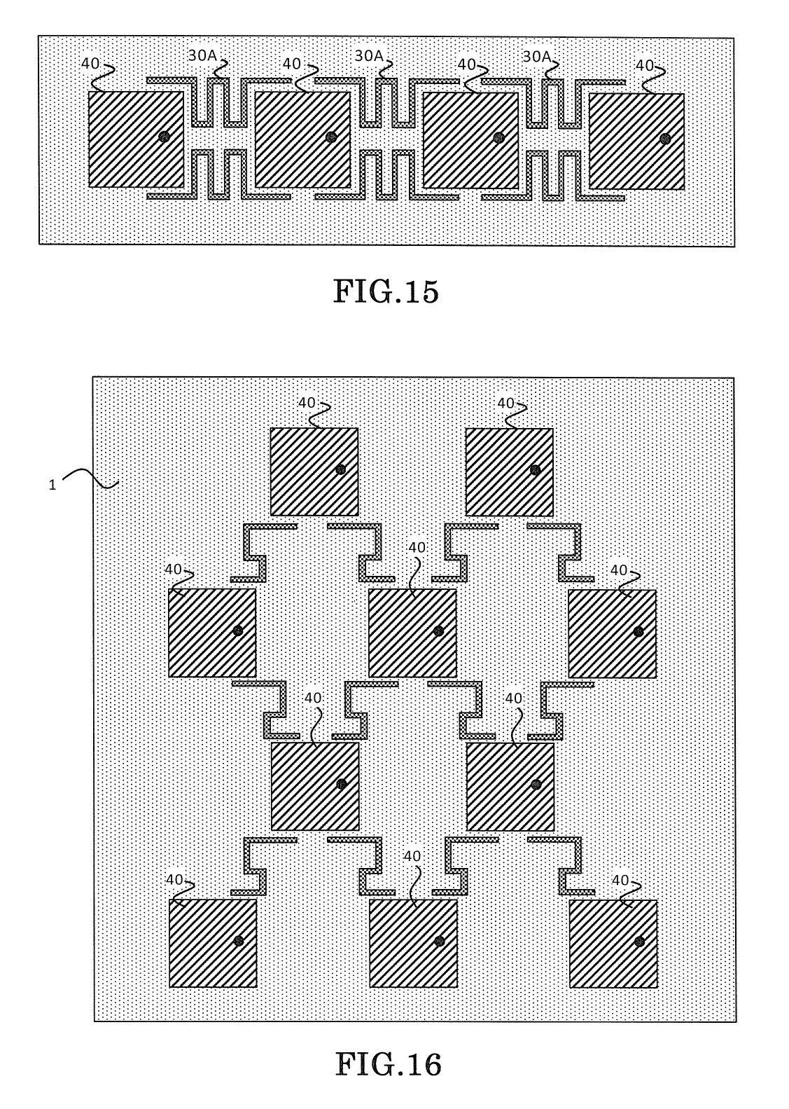

Coupling lines in the present invention do not always need to have a shape obtained by bending a straight line at the right angle, and can be like coupling lines 60 illustrated in FIG. 13. Coupling lines in the present invention may also be shaped to have a bent portion made up of a curve as in the case of coupling lines 70 illustrated in FIG. 14.

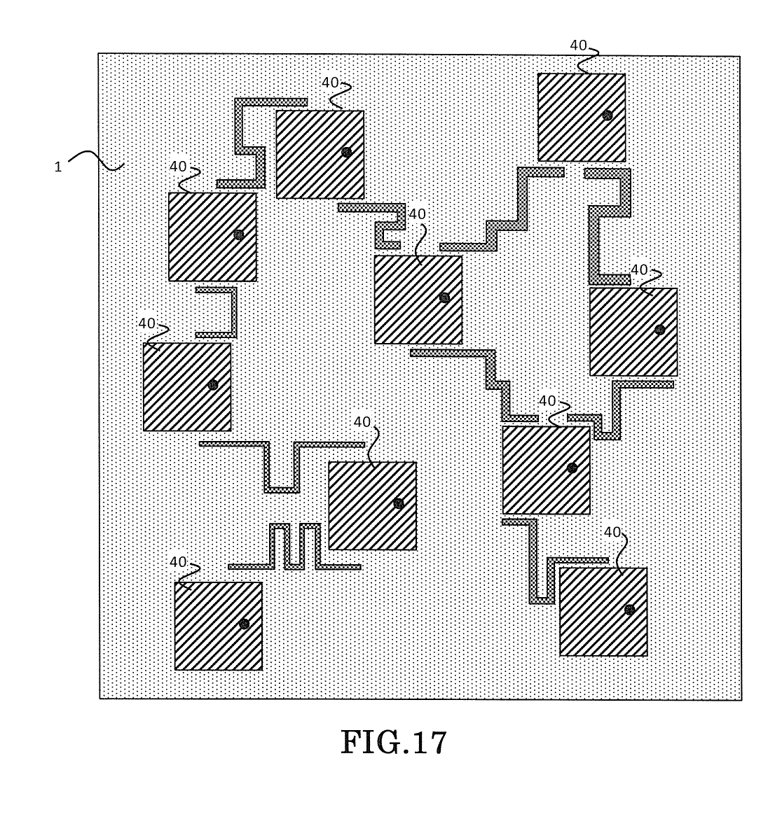

The present invention is also not limited to the case described in the first embodiment and the second embodiment in which an array of patch antennas 40 is a two-dimensional array that is a two-element array or a quadrangular array. For instance, the patch antennas 40 may form a linear array made up of three or more elements as illustrated in FIG. 15, a triangular array as illustrated in FIG. 16, and an aperiodic array as illustrated in FIG. 17.

In those cases, too, the same effects as the ones described in the first embodiment and the second embodiment can be obtained by forming at least one coupling line between adjacent patch antennas 40 to cancel out the electromagnetic wave coupled via free space and the electromagnetic wave coupled via the coupling line. The wide range of choices in how the patch antennas 40 are arrayed and in the configuration of the coupling line also gives a degree of freedom to the designing of the array antenna device.

1. An array antenna device including a plurality of patch antennas arrayed in at least a polarization direction of the plurality of patch antennas,
the array antenna device comprising:
a parallel line formed for each of the plurality of patch antennas in parallel to the polarization direction of the patch antenna, on the same plane as a patch element of the patch antenna, close to the patch element and in a magnetic field direction of the patch antenna; and
a bent line configured to connect the parallel line, which is formed close to the patch element, to another parallel line, which is formed close to another patch element, and shaped so as to be bent between adjacent patch elements,
wherein the parallel line and the bent line form a coupling line, which couples part of an electromagnetic wave excited by the patch element to an adjacent patch antenna, and
wherein, in the coupling line, a gap between the parallel line and the patch element and a length of the bent line are set so that an electromagnetic wave coupled from one patch antenna to an adjacent patch antenna via space and an electromagnetic wave coupled from the one patch antenna to the adjacent patch antenna via the coupling line cancel each other.

2. An array antenna device according to claim 1, wherein the bent line is bent in a shape of a crank.

3. An array antenna device according to claim 1, wherein the bent line is bent in a shape of a meander.

4. An array antenna device according to claim 1, wherein the bent line is bent in a shape of a curve.

5. An array antenna device according to claim 1, wherein at least two coupling lines are formed in the magnetic field direction of the patch antenna.

6. An array antenna device according to claim 1, wherein the plurality of patch antennas are arrayed into a quadrangular array.

7. An array antenna device according to claim 1, wherein the plurality of patch antennas are arrayed into a triangular array.

8. An array antenna device according to claim 1, wherein the plurality of patch antennas are arrayed into an aperiodic array.

9. An array antenna device according to claim 2, wherein at least two coupling lines are formed in the magnetic field direction of the patch antenna.

10. An array antenna device according to claim 3, wherein at least two coupling lines are formed in the magnetic field direction of the patch antenna.

11. An array antenna device according to claim 4, wherein at least two coupling lines are formed in the magnetic field direction of the patch antenna.
